(19) United States
(12) Patent Application Publication
(10) Pub. No.: US 2021/0107797 A1
(43) Pub. Date: Apr. 15, 2021

(54) CALCINATION OF PARTICULATE FEEDSTOCK USING PROCESS WASTE GAS

(71) Applicant: Pneumatic Processing Technologies, L.L.C., NEW ORLEANS, LA (US)

(72) Inventor: Michael A. JONES, Gillette, WY (US)

(21) Appl. No.: 17/071,383

(22) Filed: Oct. 15, 2020

Related U.S. Application Data
(60) Provisional application No. 62/915,449, filed on Oct. 15, 2019.

(51) Int. Cl. C01B 32/336; C01B 32/318; B01J 6/00; C01B 33/26; C01F 11/46; B04C 9/00

(52) U.S. Cl. CPC C01B 32/336; C01B 32/318; B04C 9/00; C01B 33/26; C01F 11/46; B01J 6/004

(57) ABSTRACT

The present disclosure relates to processes and apparatus for calcination of particulate feedstock using process waste gas. In at least one embodiment, a process includes heat treating a particulate carbon feedstock in a heating system to form an activated carbon. The process includes removing a waste gas from the heating system. The process includes introducing the waste gas with a particulate material in a thermal oxidizer coupled with the heating system to form a calcined material. In at least one embodiment, a process includes heat treating a particulate carbon feedstock in a heating system to form an activated carbon. The process includes separating a waste gas from the heating system. The process includes introducing the waste gas with a particulate material in a duct coupled with a thermal oxidizer.

### CROSS-REFERENCE TO RELATED APPLICATIONS

This application claims priority to U.S. Provisional Patent Application No. 62/915,449, filed Oct. 15, 2019. The above referenced application is incorporated herein by reference in its entirety.

### FIELD

The present disclosure relates to processes and apparatus for calcination of particulate feedstock using process waste gas.

### BACKGROUND

A substantial amount of fossil fuel energy is typically used to manufacture cement. However, environmental awareness over the global impact of CO₂ produced as a result of cement production and fossil fuel power plants has heightened the need to find high quality alternatives to fly ash produced by coal fired power plants and consumed by cement plants. For example, one alternative to fly ash is metakaolin (a pozzolan) which is a valuable admixture component for concrete/cement applications since it has twice the reactivity of most other pozzolans. Using, for example, 8-20 wt % of metakaolin in concrete produces a concrete mix with many performance advantages over conventional concrete/cement applications. Some of the advantages are immediate, such as the filler effect, while the pozzolanic reaction is a delayed advantage, occurring between 7 to 14 days.

However, higher performing pozzolanic materials such as metakaolin have proven economically restrictive in their use in and production of cement. For example, high reactivity metakaolin is traditionally produced using conventional flash calciners as well as rotary kilns. However, typical large commercial metakaolin calcination processes utilize fossil fuels to provide the primary heat required for calcination. In addition, waste gas from a component of a calcining apparatus can be recycled (e.g., to the calciner), but such processes only reduce energy inputs to the calciner by about 40-50%. Also, the presence of moisture after metakaolin has been formed promotes caking which can plug components of the calcining apparatus, such as a calciner. Conventional metakaolin forming apparatus and processes have yet to fully resolve this moisture issue.

Aside from the traditional fuels used to produce metakaolin, metakaolin calcination reactions do not produce CO₂. Hence, the use of metakaolin for cement applications would lower the CO₂ footprint of the cement production and yield a stronger and more desirable cement product.

There is a need for improved processes for producing metakaolin and cement containing metakaolin.

Additionally, activated carbon is a multimillion dollar industry. Processes for producing activated carbon include heat treating the carbon feed. Limited attempts have been made to calcine other materials concurrently while the carbon feedstock is being heat treated, e.g., in a reaction vessel. Conventional processes can produce a mixed product having the heat treated/activated carbon and the calcined other material. If different end uses of the materials are desired, the mixed products would need to undergo separation of the heat treated/activated carbon from the calcined other material. However, separation of concurrently calcined products if desired is most often impossible or impractical.

There is a need for improved processes for simultaneously producing activated carbon and calcined other materials concurrently while avoiding the issue of subsequent calcined coproduct separation.

### BRIEF SUMMARY

The present disclosure relates to processes and apparatus for calcination of particulate feedstock using process waste gas.

In at least one embodiment, a process includes heat treating a particulate carbon feedstock in a heating system to form an activated carbon. The process includes removing a waste gas from the heating system. The process includes introducing the waste gas with a particulate material in a thermal oxidizer coupled with the heating system to form a calcined material.

In at least one embodiment, a process includes heat treating a particulate carbon feedstock in a heating system to form an activated carbon. The process includes separating a waste gas from the heating system. The process includes introducing the waste gas with a particulate material in a duct coupled with a thermal oxidizer.

In at least one embodiment, an apparatus includes a heating system coupled with a thermal oxidizer. The apparatus includes a material source coupled with (1) the thermal oxidizer or (2) a duct coupled with the thermal oxidizer.

In at least one embodiment, a process includes heat treating a particulate carbon feedstock in a heating system to form an activated carbon. The process includes removing a waste gas comprising a fly ash from the heating system. The process includes (1) separating the waste gas from the fly ash using a cyclone collector followed by introducing a coolant to the waste gas or the fly ash, or (2) introducing a coolant to a mixture of the waste gas and the fly ash followed by separating the waste gas from the fly ash using a cyclone collector or a dust collector.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only typical aspects of this present disclosure and are therefore not to be considered limiting of its scope, for the present disclosure may admit to other equally effective aspects.

FIG. 1A is a schematic flow diagram of a portion of an apparatus for forming activated carbon and calcined other material, according to an embodiment.

FIG. 1B is a schematic flow diagram of a portion of an apparatus for forming activated carbon and calcined other material, according to an embodiment.

To facilitate understanding, identical reference numerals have been used, where possible, to designate identical elements that are common to the figures. The figures are not drawn to scale and may be simplified for clarity. It is contemplated that elements and features of one aspect may be beneficially incorporated in other aspects without further recitation.

### DETAILED DESCRIPTION

The present disclosure relates to processes and apparatus for calcination of particulate feedstock using process waste gas. In at least one embodiment, a process includes heat treating a particulate carbon feedstock in a heating system to form an activated carbon. The process includes removing a waste gas from the heating system. The process includes introducing the waste gas with a particulate material in a thermal oxidizer coupled with the heating system to form a calcined material. In at least one embodiment, a process includes heat treating a particulate carbon feedstock in a heating system to form an activated carbon. The process includes separating a waste gas from the heating system. The process includes introducing the waste gas with a particulate material in a duct coupled with a thermal oxidizer. In at least one embodiment, an apparatus includes a heating system coupled with a thermal oxidizer. The apparatus includes a particulate material source coupled with (1) the thermal oxidizer or (2) a duct coupled with the thermal oxidizer.

Processes and apparatus of the present disclosure provide formation of calcined materials, such as metakaolin, without a need to use a dedicated fossil fuel fired calcination reactor, effectively eliminating the use of fossil fuels for a dedicated calcination reactor that would otherwise be used in a conventional calcination process. For example, because the chemical reaction of kaolinite to metakaolin does not produce CO2, production of metakaolin according to processes and apparatus of the present disclosure can be a carbon-neutral value added process. Processes and apparatus of the present disclosure can further provide reduction or elimination of moisture of metakaolin product formed, reducing or eliminating caking of the metakaolin product.

In addition, processes and apparatus of the present disclosure can provide simultaneous production of calcined materials and activated carbon without a need for a subsequent separation process where possible to separate the calcined material from the activated carbon.

In addition, it has been discovered that the waste gas of a thermal oxidizer of the present disclosure can provide heat sufficient to calcine materials, such as kaolinite to metakaolin, but without thermal excursions, such as those that would otherwise form mullite. Accordingly, processes and apparatus of the present disclosure can provide high reactivity metakaolin. In addition, use of waste gases of a thermal oxidizer for calcination provide temperature leniency that would otherwise not be present in conventional calcining processes. For example, kaolinite can form metakaolin at temperatures up to about 750° C. with peak heat source temperatures up to about 1000° C., which would be lower than peak heat source temperatures used in a conventional calcining process. With processes and apparatus of the present disclosure, because waste gas is used and additional heat inputs are merely optional (and typically not included), there is more temperature leniency (without an otherwise CO₂ penalty).

### Activated Carbon

Activated carbon is a term used to describe a carbon material that has been modified to possess a high surface area. A high surface area may be useful for adsorption, deodorization, and other applications. Thus, activated carbon (AC) can refer to carbon that has had the size of its pore structure increased as compared to a carbon feedstock used to form the activated carbon. In some embodiments, activated carbon may be produced by thermal activation where carbon containing material, such as coal, becomes activated by heating it with steam and/or CO₂. A second activation process may be performed which uses various chemicals to create the open pore structure. Thermal activation and chemical activation remove residual non-carbon elements and produce a porous internal microstructure having a high surface area. For example, a single gram of such material may have about 400 to about 1,200 square meters of surface area, comprising up to about 98% of it as internal structure. The thermal and chemical activation processes can be independently used or, alternatively, can both be used to form activated carbon. In some embodiments, heating and chemical activation are performed concurrently (partially or completely).

Pore structure of activated carbon may have various classifications: Micro-pores (<1 nm), Mesa-pores (1 to 25 nm) and Macro-pores (>25 nm). Mesa-pore AC is well suited for mercury adsorption. AC can also be characterized by its particulate size range. AC in powdered form of 50 mesh and finer particulate size can be referred to as pulverized activated carbon (PAC) and the granular form of 4 to 50 mesh particulates can be referred to as granular activated carbon (GAC).

### Processes for Producing Activated Carbon

Activated carbon of the present disclosure can be produced using any suitable process that provides flue gases suitable to calcine other materials in a downstream unit (such as a thermal oxidizer).

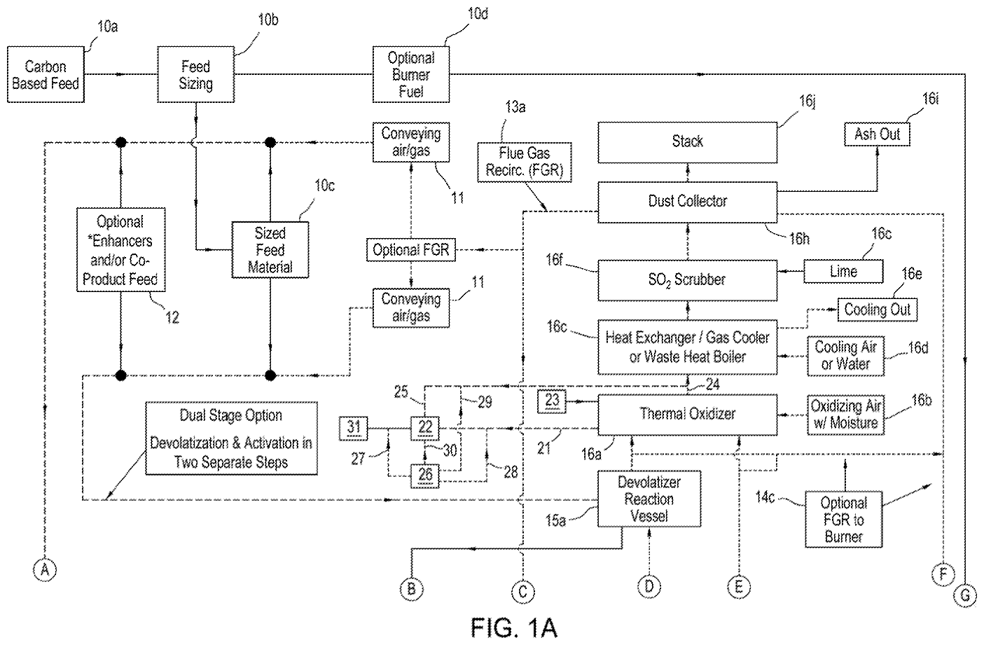

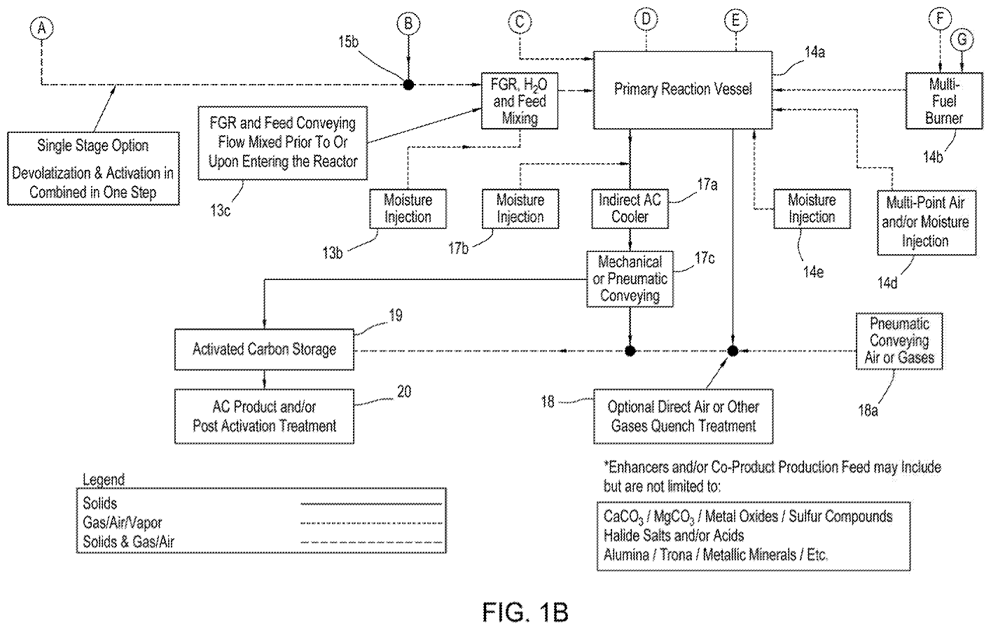

In some embodiments, processes for producing AC can involve one or more of 1) carbonaceous feed material (feedstock) preparation, 2) calcination or other heat treatment of the carbonaceous feed material, 3) activation, 4) post activation treatment, 5) process gas conditioning, and 6) AC enhancement. The calcining stage may accomplish both devolatilization and subsequent activation reactions of carbonaceous feed material in a single reaction vessel (single-stage activated carbon production) or in two separate reaction vessels (dual-stage activated carbon production). FIGS. 1A-1B are schematic flow diagrams of portions of an apparatus for forming activated carbon and calcined other material, according to an embodiment.

Carbonaceous Feed Material Preparation 10a-10d

In some embodiments, a combination of granular and pulverized AC can be produced utilizing a variety carbonaceous feed stock material. A blend of carbonaceous materials can also be created to tailor the properties of the AC. Materials that can be used include coal, biomass, and petroleum based material. For example, coal, such as lignite coal, cellulose-based materials, such as wood fibers or coconut shells, can be used. The type of feed material utilized depends on the intended use of the AC since each material produces or has unique adsorption characteristics. For example, lignite coals when activated produce an AC with excellent vapor phase mercury adsorption characteristics, while a biomass such as coconut shells produces an AC with very high overall adsorption capabilities.

In some embodiments, at least 90% of the feedstock is within one-half an order of magnitude in size for particles coarser than 0.40; at least 90% of the feedstock is within one-quarter an order of magnitude in size for particles 0.40 mm or smaller in size; or at least 90% of the feedstock has one-quarter to one-half an order of magnitude in size for particles of about 0.40 mm.

Preparation of the feed material 10b can vary depending on feed stock and the desired end product. Generally, producing a more granular AC can be effective since a good quality product can be produced and the AC can be further ground if necessary. Process advantages and product quality indicate that high quality AC can be produced using granular feed with a defined feed size distribution, such as feedstock granules of at least 240 mesh or greater in size. A typical feed preparation for lignite coal could include primary crushing followed by subsequent roll crushing to minus 10 mesh. Roll crushing might be preferred over other crushing processes since it produces a low amount of fines. Crushed material can be screened with the oversized material being re-circulated to the mill if required. Material substantially finer than 120 mesh can be processed separately to produce an AC with different characteristics. Prepared feed material can be stored in a silo or hopper. Moisture in the carbonaceous feed material 10a can also be beneficial to help buffer the carbonaceous feed material from various adverse early reaction conditions in the reaction vessel 14a and/or 15a due to excessive initial reaction vessel temperatures. Free moisture content of the carbonaceous material will be limited by the particle size and flow characteristics of the feed material. Feed material 10a may remain free flowing to properly feed, convey, and disperse into the reaction vessel cyclonic flow.

Fine feed material of less than 120 mesh tends to devolatilize and activate faster than coarser granular feed resulting in fines being over activated or gasified resulting in not only product loss but increased residual ash. The gasification of fines can also lead to excessive loss of activating gases thereby diminishing the quality of remaining AC particulates. Further compounding these issues is the loss in efficiency and process capacity. In general, every pound of carbon gasified or carried out of the system increases the flue gas conditioning needed. This increased gas conditioning requirement further reduces plant production capacity. Every pound lost through carry over or excessive gasification may result in more than a pound of lost production capacity.

The hopper or silo 10c can be a mass flow type that refers to a hopper in which the first product in will be the first product out. This hopper acts as a receiver for prepared carbonaceous feed material that can be metered to the calciner. The hopper provides surge capacity for constant, uninterrupted material feed to the calciner. As the hopper level lowers, the carbonaceous feed from the grinding circuit is proportionally increased and vice versa, allowing the grinding circuit to run intermittently allowing time for maintenance. The material being discharged and metered from the hopper is introduced into a pneumatic conveying line and conveyed to the calciner reaction vessel. Of course, a calciner is used as an example activation system, and the processes of the present disclosure can be practiced in other systems suitable for heating a particulate carbon feedstock to form an activated carbon.

In situations where gas or fuel oil is not available for the reaction vessel, multi-fuel burner 14b or are limited either for economical or logistical reasons and when coal is utilized as the carbonaceous feed it is possible to divert a portion of the carbonaceous feed 10d and prepare it for use as a primary or secondary fuel in the multi-fuel burner 14b.

### Conveying Gas and Blowers 11

A conveying air/gas blower 11, which can include air, re-circulated flue gases (FGR), other gases or a combination, can be utilized to convey the carbon feedstock to the reaction vessel(s) 14a and/or 15a. The carbon feedstock can be also mechanically conveyed to the reaction vessel(s) and mixed upon entering the reaction vessel(s) with a cyclonic flow of air, FGR, other gases or a combination, that were previously or concurrently introduced into the reaction vessels(s), thereby creating the desired cyclonic feed material flow pattern.

Activated Carbon Enhancers and/or Simultaneous Co-Product Production 12 and 20

In some embodiments, the simultaneous production of activated carbon with other industrial minerals, metallic minerals, oxides, and salts can be performed to produce an “enhanced AC” (EAC). This simultaneous production of various materials followed in some cases by additional acid or base treatment creates a ready to use multi-functional EAC blend with unique characteristics such as SO₂ removal, paramagnetic properties (metallic mineral, oxides, or salts, such as nickel or iron), halogenation (e.g., halide acid, sodium bromide, calcium bromide, iron bromide), or EAC with low foaming indexes to name a few examples. The presence of many of these co-products during activation can also in some cases enhance the physical AC pore size distribution and adsorption properties. Alternately, the co-product feed and the carbonaceous feed can be mechanically premixed and metered to the system from the same feed location.

Enhancement of AC using flash activation can be performed by simultaneous or co-produced AC products where each component could be produced separately using flash calcination but are produced concurrently. The co-product AC production can include industrial minerals such as lime, trona, alumina, and clay. One example of a simultaneously produced co-product AC is calcium oxide (lime) and activated carbon. The utilization of flash activation to simultaneously calcine lime and devolatilize and activate AC, providing a product which may be suitable for SO₂ and Hg removal in power plants.

Enhancement of AC using flash activation can be performed by including additives with the carbonaceous feed material to enhance the AC during activation but that would not typically be flash calcined by themselves. Additives can include metallic minerals, oxides and salts. For example, addition of sodium bromide to the carbonaceous feed material and flash activating the mixture can produce a well halogenated AC with numerous enhanced characteristics derived from the concurrent activation and halogenation of the AC. Halogenated AC can have an ability to oxidize vapor phase contaminates such as elemental mercury from coal fired power plant flue gas emissions. Another example of this second category is the addition of a metallic metal or oxide to the carbonaceous feed material. Such a mixture when heated at activation temperatures and under activation conditions can produce a uniform metal rich AC which can serve as a catalyst or as a precursor for additional AC treatment. Such an AC product can be engineered to be magnetic or paramagnetic.

Enhancement of AC using flash activation can be performed by post treatment of AC produced under either of the first two processes described above using an acid or base or a combination. For example, the reaction of lime enhanced AC with hydrobromic acid can produce a halogenated (calcium bromide) enhanced AC. Another example is the treatment of an iron enriched AC with hydrobromic acid to produce a halogenated (iron (II or III) bromide) AC with paramagnetic properties.

Introducing Carbonaceous Feed to the Process Mixed with a Second Gas, e.g., Flue Gas Recirculation (FGR) 13a-13b

A second gas 13a, e.g. re-circulated flue gas (FGR), may be mixed with the blower 11 or injected directly into the reaction vessel 14a to provide additional gas flow to promote cyclonic rotational flow velocity and flow profile within reaction vessel 14a, enabling independent control of FGR 13a rate without affecting material feed conveyance. The FGR is an excellent source of activating gases due to its high moisture and significant amounts of CO₂ along with low amounts of O₂. Since the presence of excess oxygen consumes carbon, the utilization of FGR can help suppress early combustion reactions.

Moisture 13b and other properties of the second gas, e.g., FGR 13a, can be adjusted, allowing the operator to change and control the heating environment such that a wide variety of reaction conditions and products is achievable. Adjusting properties of the second gas can provide the carbonaceous feed material with an additional buffer against early peak flame temperatures and adverse reactions encountered during the initial injection.

The carbon feedstock 10a can be conveyed to the reaction vessel 14a using conveying air/gas blower 11, FGR 13a, other gases or a combination, mixed prior to or upon entering the reaction vessel 14a (as shown by box 13c) to convey the carbon feedstock to the reaction vessel. Although pneumatic conveying is an example process of introducing the carbonaceous feed material into the reaction vessel, feed material can additionally or alternatively be mechanically conveyed to the reaction vessel and mixed immediately upon entering the reaction vessel with a flow of air, FGR, other gases or a combination, from blower 11, FGR 13a and/or 13b that were either previously or concurrently introduced into the reaction vessel thereby creating a desired cyclonic feed material flow pattern.

In addition, as previously mentioned, moisture in the carbonaceous feed material 10a can protect the carbonaceous feed from adverse early reactions. High moisture yet free flowing carbonaceous feed can be beneficial whether using FGR, air, other gases, or a combination to create and maintain the cyclonic feed material flow.

The flow rate of 11, 13a and 13b provide the force to create the cyclonic flow within reaction vessel 14a. The cyclonic flow in the reaction vessel 14a in conjunction with the feed conveying gas and or secondary gas composition creates a more uniform AC product by buffering the carbonaceous feed from excessive reaction vessel temperatures caused by the burner flame and/or from excessive partial combustion of the feed, due to centrifugal forces acting on the particles in such a manner that they travel in close proximity to the reaction vessel walls. The cyclonic flow in conjunction with the feed conveying gas and or secondary gas composition allows a more gradual blending of feed material and hot burner combustion gases thereby improving the yield and carbon pore structure development. The cyclonic flow also enables the reaction vessel to retain the coarser feed material longer than the finer material. Cyclonic gas flow rotational velocities within the reaction vessel may be about 90 RPM or greater average rotational velocity such as about 120 RPM to about 240 RPM in the “burn” or oxidation zone of the reaction vessel. By utilizing this process, adverse carbon particle surface reactions, ash fusion, excessive gasification and product loss is avoided. In addition, cyclonic flow in the reaction vessel increases particulate retention time by creating a helical material flow pattern thereby increasing the particle path length.

The reaction vessel 14a can have both oxidizing and reducing conditions in which devolatilization and activation predominately occur in distinct regions of the reaction vessel. The control of the cyclonic gas flow rate, moisture percentage, and or activation content can change the oxidizing conditions to reducing conditions and vice versa. The control of the cyclonic gas flow rate, moisture percentage, and or activation content in turn also affect the cyclonic rotational speed, reaction time, temperature, oxidizing and reducing conditions, and other aspects of a devolatilization and activation process. Therefore the air and gas flows from 11, 13a and/or 13b may be used for generating desired reaction vessel flow conditions.

Single Stage Activated Carbon Production 14a-14e

The reaction vessel 14a is a component of a pneumatic flash calciner (PFC). As previously mentioned, the calcination of carbonaceous material to produce AC can be classified as two processes. The first process is devolatilization where moisture and volatile carbonaceous compound are driven out of the feed material particulates. The second process is activation of the remaining carbon char particulates using an activating gas such as H₂O, CO₂, and/or O₂. As previously stated, though these processes imply that devolatilization and activation are separate reactions, the processes may overlap to a large degree depending on process conditions. For example, a portion of the carbonaceous feed may be activated during devolatilization. Likewise, a portion of the carbonaceous feed may be further or more completely devolatilized during activation.

The activation reactions include but are not limited to the following;
Primary Activation Reaction Examples:

C30 H₂O→CO+H₂

C+CO₂→2CO

C+O₂→CO₂
Secondary Activation Reaction Examples:

CO+H₂O→CO₂+H₂

2CO+O₂→2CO₂

In some embodiments, a standalone production process for producing AC is performed that utilizes rapid devolatilization in a conditioned high temperature gaseous environment suitable for subsequent and/or concurrent carbon activation. This standalone production process may be referred to as “Single-Stage” AC production.

Portions of the carbonaceous feed undergo devolatilization while other devolatilized portions of the particulate material are advancing to be activated, enabling the particulate feed material to devolatilize and activate in rapid succession. The retention time involved for substantially or fully complete devolatilization/activation are temperature and pressure dependant but can generally be accomplished within two to fifteen seconds. The temperature involved again depends on the type of carbonaceous feed material utilized. In some embodiments, the temperature can be about 650° C. to about 1150° C. The reaction vessel can be operated under oxidizing conditions transitioning to reducing conditions to promote AC yield and production rates. The pressure can be generally maintained near atmospheric conditions. Also, the heat generated through the burner may be about 4,000 BTU per pound of activated carbon to about 10,000 BTU per pound of activated carbon.

The main calcine reaction vessel 14a can be a vertical, round, open chamber fitted with a centrally mounted vertically oriented burner 14b. In some embodiments, vessel 14a has an inner length to inner diameter ratio of about 2:1 to about 6:1, such as about 4:1. The burner provides heat input used for calcining. The burner can be fired under stable oxidizing conditions with gas/oil or coal fuels. Reducing conditions in the calciner reaction vessel occur when the carbonaceous feed material consumes the remaining excess air thereby creating an oxygen deprived environment. A reason the burner might be operated under oxidizing conditions is to promote stable operation and to ensure that the AC produced is not excessively contaminated with carbon from the burner fuel sources which have been exposed to substantially different conditions. Operating the reaction vessel to transition and operate under reducing (oxygen depleted), activation favorable (CO₂ and moisture laden gases), conditions meant the produced AC should be separated from the activating gases at elevated temperatures. The reducing conditions also involve the separated gases to be subsequently oxidized to destroy the resulting CO and other volatile gases. Flue gas recirculation 14c can also be utilized with the burner from several sources such as after the flue gases has been oxidized to help control burner flame temperatures. Alternatively, FGR can be supplied via 14c from after the reaction vessels 14a or 15a still having considerable amounts of combustible gases available to lower the fuel requirements of the burner 14b.

As described above, a process for introducing feed material into the reaction vessel can include introducing the material pneumatically. For example, the feed material from the metering feeder at the bottom of the feed hopper(s) can be conveyed with air and mixed with a mixture of a conveying gas 11 and a second gas 13a (e.g., re-circulated flue gases, a.k.a. flue gas recirculation (FGR)). This pneumatic stream can be introduced into the calciner tangentially at either a single point or multiple points. The second gas such as FGR enhances the conditions required for good activation by providing the reaction vessel with additional H₂O and CO₂ for activation. The tangential injection produces a cyclonic upward flowing vortex. This vortex traveling vertically upward allows the material to act as a buffer between the reaction vessel walls and the hot burner gases. As the material is conveyed vertically the reaction vessel gas temperature is lowered, and the material temperature is raised to the point of de-volatilization and activation. The vortex allows coarse material to be retained slightly longer than the fine material, producing a more uniform AC product. This pneumatic process is capable of a wide turn down ratio and can utilize various fuels.

The reaction vessel 14a has supplemental air and/or moisture injection ports 14d at various points along the reaction vessel. These injection ports allow additional flexibility and control in maintaining flow profiles and for modifying oxidizing and reducing zone conditions. The greater flexibility enables well defined reaction regions in the reaction vessel.

The vertically oriented burner 14b is equipped with a cleanout mechanism on the bottom to allow for the continuous or intermittent removal of difficult to convey materials that have fallen out of the calcining pneumatic flow. The material discharged from the burner can either be discarded or conditioned and returned to the system. The temperature of the reaction vessel can be primarily controlled by the feed rate of the material. For example, the higher the feed rate to the reaction vessel, the lower the reaction vessel temperature and vice versa, allowing the burner to fire at near optimal conditions and helping to maintain gas flow consistency as well. The change in temperature is rapid when controlling with change in feed rate and can change the temperature in a matter of a few seconds. Whereas, changing the temperature by using air/fuel ratios is much slower, involving minutes to change the temperature and potentially leading to the system modulating. Reaction vessel temperatures can also be primarily controlled using moisture injection after the system has achieved stable operation. The calciner materials of construction can be designed for operating temperatures of about 1300° C. or less.

The material can exit the top of the reactor portion of the reaction vessel tangentially. The tangential outlet helps to sustain the vortex in the reaction vessel. The material exiting tangentially enters a high temperature cyclone separator portion of the reaction vessel. The tangential outlet helps improve the cyclone efficiency since the material is partially segregated from the gas flow as it travels along the outer wall of the reactor portion of the reaction vessel and duct leading to the cyclone. In the cyclone, temperatures are maintained at or above the minimum activation temperature. It can be important to separate the AC product from the gaseous products at elevated temperatures, which prevents the AC from picking up gaseous contaminates (that are adsorbable at lower temperatures) prior to AC discharge insuring a high quality product. Upon discharging the AC from the cyclone the material remains under reducing conditions.

During operation of the flash calciner, a moisture injection system 14e can be control looped to a temperature limit set point and utilized to prevent system temperature from rapidly exceeding high temperature limits under the process conditions. When transitioning from oxidizing to reducing conditions, the increase in carbonaceous feed increases temperature until excess oxygen is consumed. After the excess oxygen is consumed, further increases in carbonaceous feed will lower temperature. Moisture will also buffer the temperature, thus allowing the system to remain at operating temperatures during transition. Alternatively, preheated combustion air can be bypassed in favor of ambient air thereby also reducing the process temperatures during transitions. Also FGR can be added in excess further helping to mitigate adverse combustion reactions associated with operating condition transitions.

When transitioning from reducing to oxidizing, residual carbon on the reaction vessel walls will combust resulting in a temperature spike. This spike will occur even if all feed and burner fuels are shut off as long as air continues to enter the system. The utilization of moisture injection 14e will again buffer the temperature during transition until residual carbon is consumed. Alternatively, preheated combustion air can be bypassed in favor of ambient air thereby also reducing the process temperatures during transitions. Also, FGR either from 13a or 14c can be added in excess further helping to mitigate adverse combustion reactions associated with operating condition transitions.

Dual Stage Activated Carbon Production 15a-15b

In some embodiments, production of AC is performed using a dual stage process. Staging the production of AC can in some cases be beneficial. Staging means that the carbonaceous feed is first de-volatilized in a flash calcination stream and then activated in a separate flash calcination stream. The stages may be completely separate calcination units with separate exhaust streams or the stages can be incorporated into one unit and operated in series.

A single AC production plant with two stages can be a pneumatic flash calciner (PFC) where the waste heat stream from one stage supplies the heat for the second stage. In this configuration the activation stage is the high temperature stage and the de-volatilization stage is the lower temperature. The carbonaceous feed would enter the waste heat gas stream from the activation stage and subsequently devolatilize. The devolatilized carbon is then fed into the activation stage. The activated carbon is then separated from the gas flows and discharged.

A dual stage process can begin with the carbonaceous feed material 10 being conveyed pneumatically or mechanically into a devolatilization reaction vessel 15a. Pneumatic conveying of carbonaceous feed into the reaction vessel can utilize FGR gases as the conveying medium to help reduce carbon loss. Alternatively, ambient air can be utilized as the conveying air medium. The feed material enters the reaction vessel, which also carries process gases from the calciner reaction vessel 14a that still has considerable waste heat available. The material is dispersed into the gas flow that has sufficient heat available from the preceding activation stage to devolatilize the carbonaceous feed. The process gas stream remains deprived of oxygen which helps to reduce carbon loss and devolatilized char and gases are conveyed pneumatically into a cyclone separator. In the cyclone, the gases and solids are separated with the solids discharging into a surge hopper. The separated gases continue to the process gas treatment portion of the process. The surge bin acts as a receiver for devolatilized carbon feed material that is metered to the activation reaction vessel 14a. The surge bin provides surge capacity for constant, uninterrupted material feed to the calciner reaction vessel. Feed material discharges from the bottom of the surge bin through a high temperature variable speed airlock.

The level of devolatilized carbon feed material in the surge bin is maintained by adjusting the carbonaceous feed rate from the primary feed hopper 10c at the beginning of the process. As the level lowers, the feed is proportionally increased and vice versa, which helps maintain a constant load on the system and keeps the system balanced. The level monitoring process can be a direct contact type level indicator or the surge bin can be located on load cells. The surge bin can be constructed out of materials designed to handle reducing gases and materials in excess of about 650° C.

The surge bin is also configured to return a portion of dried material to an upstream feed back-mixer if required to enable back mixing with the raw feed to dry the feed sufficiently to produce a free flowing feed product. The amount of back mixing, if applicable, will depend on the initial moisture content of the feed.

The devolatilized char is then metered into a pneumatic convey line 15b containing FGR gases to prevent char oxidation. Also, solid, liquid, and/or gas additives can be introduced at this point, i.e., after devolatilization and prior to activation. The char is then introduced tangentially into the activation reaction vessel 14a, which can be operated in the same manners as described above with the exception that the devolatilization reactions have already been substantially completed. The AC discharge and product handling may be the same regardless of whether a single stage or multiple devolatilization and activation process is performed.

As previously mentioned dual stage production can also be accomplished using two separate flash calciners operating at different temperatures. One unit can produce devolatilized char and then feed the other calciner reaction vessel that would activated the char to produce AC. Though considerably less efficient, such a process could allow each stage to have separate emissions control equipment and differing process rates.

Process Gas Treatment 16a-16j

Waste gas (flue gas) produced from forming activated carbon is then treated. The flue gas treatment may generally involve the destruction and/or removal of regulated emissions as well as utilization or control of waste heat. In some embodiments, a thermal oxidizer (T.O.) vessel 16a is used to complete combustion reactions such as H₂, CO, and volatile organic compounds (VOCs) created during the AC production process as well as control NO_{X} through the use of selective non-catalytic reduction (SNCR) technologies. Treatment of flue gas may additionally or alternatively be performed after dust collection with the use of externally heated thermal oxidizer or by use of catalytic oxidation equipment. Typically, a T.O. positioned immediately following the AC production vessels is used, allowing use of the high gas exit temperatures from an AC production vessel, in conjunction with a supplemental burner if desired, to effectively oxidize the process gases with the addition of air 16b at oxidation temperatures, reducing or eliminating the use of external heat.

After process gases have been thermally oxidized they are cooled using a waste heat recovery boiler, an air to gas heat exchanger, a direct quench (e.g., from coolant provided by a coolant source 26 via a duct), or a direct spray cooler 16c depending on the site-specific requirements. The cooling medium 16d can be either air or water and is either vented or utilized in some manner such as a waste heat boiler. In the case of cooling by heat exchange with air, a portion of the heated air 16e is utilized as preheated combustion air for the burner 14b.

In some embodiments, a method of cooling includes heat treating a particulate carbon feedstock in a heating system to form an activated carbon. The method includes removing a waste gas including fly ash from the heating system. The method includes (1) separating the waste gas from the fly ash using a cyclone collector followed by introducing a coolant (e.g., air) to the waste gas or the fly ash, and/or (2) introducing a coolant (e.g., air) to a mixture of the waste gas and the fly ash followed by separating the waste gas from the fly ash using a cyclone collector or a dust collector. Quenching with a coolant allows the apparatus and processes of the present disclosure to be flexible, such that when co-calcining is not performed, the advantageous heat balance can be provided for processes for producing activated carbon (without co-calcining a particulate material in a thermal oxidizer or duct thereof).

In most cases depending on the feed material, site permit, and emissions limitation, SO₂ abatement equipment 16f may be used. There are several options available such as lime base 16g or NaOH based SO₂ scrubbing systems. For stringent SO₂ removal, a spray dryer lime based scrubber can be very effective and produces a dry waste stream. SO₂ removal efficiencies of over 90% are routinely achieved.

Dry particulate collectors otherwise known as dust collectors 16h or baghouses are used to remove remaining particulate matter. Gas temperatures remain above the wet bulb temperature of the gas steam. The cloths to air ratios are generally in the range of 4 to 1 or less for long bag filter life. After the gases are filtered, a portion of the gases are re-circulated either for material conveying or for burner flame temperature control. Ash 16i collected from the dust collector contains fly ash and in the case of lime based scrubbing the ash contains significant amounts of CaSO₃/CaSO₄ and un-reacted Ca(OH)₂.

After the dust collector the gases are provided through a system draft fan and are sent to the stack 16j. The height of the stack and diameter are functions of gas volumes and site requirements. A stack can include test ports and platforms with associated equipment.

Calcining Particulate Materials using a Thermal Oxidizer (or a Duct thereof)

In some embodiments, processes include introducing the gas from a reaction vessel into a thermal oxidizer (or a duct coupled with a thermal oxidizer) with a particulate material to form a calcined material. The thermal oxidizer can be any suitable thermal oxidizer, such as thermal oxidizer 16a. Particulate material can be introduced into the thermal oxidizer (or a duct thereof) via a particulate material source (such as particulate material source 23). A particulate material source can be a dry hopper, and air or FGR can be used to promote flow of the particulate material into the thermal oxidizer. The particulate material can additionally or alternatively be provided mechanically (e.g., via an auger) to the thermal oxidizer or duct thereof.

A particulate material can be kaolinite, calcium oxide, calcium carbonate, a zeolite, calcium sulfate dihydrate (gypsum), or combination(s) thereof. In some embodiments, a particulate material is greater than 85 wt %, such as greater than 95 wt %, of one type of particulate material, such as kaolinite, based on the total weight of particulate material. In some embodiments, a calcined material is metakaolin, calcium sulfate hemihydrate, gypsum, lime (CaO), a zeolite, a silicate, or combination(s) thereof.

The waste gas from the reaction vessel (used to form activated carbon) can have a temperature of about 600° C. to about 1,000° C., such as about 750° C. to about 900° C., at some time while introducing the waste gas into the thermal oxidizer, which can promote calcination of the particulate material. In some embodiments, the waste gas has about 5 vol % to about 40 vol % water, such as about 15 vol % to about 25 vol % water. The advantageous moisture content of the gas helps to buffer the particulate material from reaching peak particle excursion temperatures and provides advantageous surface area of calcined materials. The waste gas may include aluminosilicate or fly ash carry-over from activated carbon production.

During calcination, because the particulate material occupies volume within the thermal oxidizer, a thermal oxidizer of the present disclosure may have a larger volume than a conventional thermal oxidizer to provide space for the particulate material without affecting performance of thermal oxidation of waste gas. In some embodiments, the particulate material is introduced to the thermal oxidizer at a plurality of locations on the thermal oxidizer (e.g., introduced via a plurality of ducts (and one or more particulate material sources) coupled with the thermal oxidizer). For example, a plurality of ducts can be about 2 ducts to about 8 ducts, such as about 2 ducts to about 4 ducts, each coupled with the thermal oxidizer. Duct(s) can provide the particulate material to the thermal oxidizer (or duct) pneumatically (e.g., using air or waste gas) or mechanically (e.g., with an auger).

In some embodiments, a thermal oxidizer has an interior diameter of about 5 ft to about 20 ft, such as about 10 ft to about 15 ft, such as about 13 ft. A thermal oxidizer can have an interior height of about 50 ft to about 110 ft, such as about 60 ft to about 80 ft, such as about 70 ft.

A retention time of a particulate material/calcined material in a thermal oxidizer can be from about 0.2 seconds to about 3 seconds, such as about 0.6 seconds to about 1.5 seconds, such as about 0.75 seconds to about 1 second. The geometry of a thermal oxidizer (e.g., location of particulate material source/duct thereof and a location of a duct of the thermal oxidizer for removing calcined material) can be determined based on a desired retention time of the particulate material/calcined material for a desired particulate material/calcined material.

A retention time of a particulate material/calcined material in a duct coupled with a thermal oxidizer can be from about 0.2 seconds to about 3 seconds, such as about 0.6 seconds to about 1.5 seconds, such as about 0.75 seconds to about 1 second.

Additionally or alternatively, the gas from a reaction vessel can be introduced with a particulate material in a duct coupled with the thermal oxidizer. The duct coupled with the thermal oxidizer can be fluidly coupled with the thermal oxidizer (such as duct 24). The duct can provide pneumatic convey velocities and facilitate in-flight calcination of a particulate material, such as metakaolin. Also, in some embodiments, calcining the particulate material in a duct provides for calcination in a smaller volume (as opposed to a thermal oxidizer) which may provide fewer injection locations on the duct (as compared to injection locations for calcining in a thermal oxidizer to provide uniform flow).

In some embodiments, the particulate material is introduced to the duct of a thermal oxidizer at a single location or a plurality of locations on the duct (e.g., introduced via a plurality of ducts (and one or more particulate material sources) coupled with the thermal oxidizer duct). For example, a plurality of ducts can be about 2 ducts to about 8 ducts, such as about 2 ducts to about 4 ducts, each coupled with the duct of the thermal oxidizer. Duct(s) can provide the particulate material to the thermal oxidizer duct pneumatically (e.g., using air or waste gas) or mechanically (e.g., with an auger).

Additionally or alternatively, heat exchanger duct(s) or tube(s) (not shown) can be disposed in (e.g., disposed through) the thermal oxidizer such that the particulate material can absorb heat indirectly from the gas within the thermal oxidizer without the particulate material being in fluid contact with the gas. Forming calcined material via a duct disposed through the thermal oxidizer provides calcined material without a need for separation from fly ash formed in the thermal oxidizer.

Because the particulate material occupies volume within the heat exchanged duct(s) or tube(s), the duct may have a larger volume and/or diameter than a conventional duct of a thermal oxidizer.

In embodiments where calcined material is formed in a thermal oxidizer, calcined material may be removed from the thermal oxidizer via a duct disposed at a location on the thermal oxidizer (or via a plurality of ducts disposed at various locations on the thermal oxidizer). A duct (such as duct 21) or plurality of ducts (not shown) may be disposed at a location that is below ¼ of the height of the thermal oxidizer, which provides easy removal of the calcined material using vertical downflow of the particulate material as it is calcined in the thermal oxidizer. Similarly, in some embodiments, particulate material source 23 is coupled with the thermal oxidizer at a location that is between ¼ and ¾ height of the thermal oxidizer, such as between ¼ and ½ height, which promotes calcination of the particulate material as it downflows vertically in the thermal oxidizer. Because the hottest operating temperatures are typically located at the top of a thermal oxidizer, the particulate material source (injection location of particulate material) can be at a location sufficient to not overheat the calcined material (e.g., metakaolin). In some embodiments, a duct (such as duct 24) may be disposed at a location that is about ¼ to about ½ of the height of the thermal oxidizer.

The combination of particulate material flow rate, the duct location (or location of the plurality of ducts) along the thermal oxidizer or duct thereof, and gas (waste gas) flow rate and geometry into the thermal oxidizer can be such that turbulent swirling of the particulate material in the thermal oxidizer (or duct thereof) is promoted to provide uniform calcination of the particulate material.

A collector (such as collector 22) can be coupled with the thermal oxidizer via a duct (such as duct 21). The collector can be disposed at a location that is below ¼ height of the thermal oxidizer. A collector can be a dust collector (such as a baghouse) or a cyclone collector.

Additionally or alternatively, in embodiments where calcined material is formed in a duct coupled with a thermal oxidizer (such as duct 24), calcined material may be removed from the duct via a second duct (such as duct 25) coupled with the first duct (the duct coupled with the thermal oxidizer such as duct 24).

Additionally or alternatively, the calcined material (whether calcined in the thermal oxidizer and/or a duct coupled with the thermal oxidizer) may be maintained in combination with the gas/fly ash formed (e.g., in embodiments where vertical downflow is not substantial and flow of waste gas through the thermal oxidizer is sufficiently large). In such embodiments, the calcined material may be flowed, along with the gas/fly ash, to additional treatment processes (such as heat exchanger 16c, SO₂ scrubber 16f, dust collector 16h, and ash out 16i). In some embodiments, the calcined material is metakaolin which, in combination with the fly ash formed, provides excellent starting material that can be used to form cement.

It has been discovered that high quality calcined material can be formed. For example, a calcined material can be metakaolin that is high reactivity metakaolin (HRM). High reactivity metakaolin has 90% or greater content of (SiO₂+Al₂O₃+Fe₂O₃). HRM has a specific gravity of about 2.4-2.6 (H₂O=1). HRM has a particle size that is less than fly ash but greater than silica fume. The inventor has discovered that HRM can be formed using one or more embodiments of the present disclosure even though waste gas (having impurities) from an activated carbon reaction vessel is used to perform the calcining.

### Cooling and Collecting Calcined Material

In some embodiments, the calcined material is removed from a thermal oxidizer and introduced via a duct (such as duct 21) to a collector (such as collector 22). Additionally or alternatively, in embodiments where calcined material is formed in a duct coupled with a thermal oxidizer (such as duct 24), calcined material may be removed from the duct via a second duct (such as duct 25) that is coupled with the first duct (the duct coupled with the thermal oxidizer such as duct 24). The calcined material of the duct (such as duct 25) is introduced to a collector (such as collector 22).

As mentioned above, the collector can be disposed at a location that is below ¼ height of the thermal oxidizer. A collector can be a dust collector (such as a baghouse) or a cyclone collector.

Separating the waste gas from the calcined material can be performed using the collector (such as collector 22) followed by introducing air to the waste gas and/or the calcined material via a coolant source, such as an air source (such as coolant source 26 via line 27 or line 30 using pressure to provide the coolant to the waste gas and/or the calcined material). Waste gas from the collector (such as collector 22) can still have substantial heat and be used for pre-heating (not shown) particulate material or to generate steam for other uses. The air quench of the calcined material reduces or eliminates caking of the calcined material, because there is little or no opportunity for moisture readsorption or condensation onto the calcined material. In addition, the air quench of the calcined material can be used for calcined material formed from lime, which typically need high heat-treatment temperatures and need to be rapidly cooled or separated to avoid recarbonation reactions.

Alternatively, air can be introduced via a coolant source (such as coolant (e.g., air) source 26 via line 28 or line 29) to a mixture of the waste gas and the calcined material followed by separating the waste gas from the calcined material using a collector (such as collector 22). An air quench of these embodiments can not only cool the calcined material and waste gas but will also lower the gas moisture percentages, reducing or eliminating caking of the calcined material. An air quench of these embodiments may provide a simple, two-step cooling/separation process to obtain desired calcined materials.

In some embodiments, introducing air to the calcined material (or to the mixture of the waste gas and the calcined material) reduces a first temperature of the calcined material (or mixture) to a second temperature of about 110° C. to about 200° C.

Cooled calcined material (e.g., at about 110° C. to about 200° C. or less than about 110° C.) in a collector (such as collector 22) can be collected or sent for further processing (e.g., in processing unit 31). Further processing can include one or more of cycloning or dust collection (e.g., processing unit 31 is one or both of a cyclone or a baghouse). Cooled calcined material can be removed from processing unit 31.

Waste gas from collector 22 and/or processing unit 31 can be sent for further processing (not shown). Further processing of the waste gas can include drying, steaming, and/or air preheating. Additionally or alternatively, the waste gas can be sent to one or more vessels (such as the reaction vessel 14a or thermal oxidizer 16a).

### Activated Carbon Product Cooling 17

AC production from the reaction vessel 14a is hot and will readily combust or oxidize upon exposure to ambient air. To avoid this, the AC is cooled either indirectly by indirect AC cooler 17a or by direct moisture injection quencher 17b. In some embodiments, AC cooling is performed using indirect cooling, where the hot AC is cooled by mechanical or pneumatic conveyor 17c (as further described below) during pneumatic transport to product storage silo 19. In other words, the hot AC is not quenched to achieve cooling. To ensure that the product quality remains high, the production of predominately granulated AC can be achieved, providing a low amount of surface area that is inadvertently exposed to adverse conditions. Granular AC can be further processed and ground into pulverized AC if desired.

After cooling the AC, the AC is either mechanically or pneumatically conveyed via conveyor 17c to storage silo 19. Mechanical conveying includes screw conveyors, bucket elevators, etc. Pneumatic conveying can be accomplished with ambient air, dried air, or other gases. Since contact between hot AC and gases can alter the AC characteristic and quality, care should be taken to avoid accidental loss of quality.

### Activated Carbon Product Post Process Surface Treatment 18

In some embodiments, hot AC can have its characteristics altered by using a hot AC direct quench with a pneumatic conveying gas source 18 (e.g., air stream). This rapid quench changes the surface characteristics of the AC in various ways depending on the gas type, temperature, and retention time. A direct quench process is readily controllable and can be useful in producing AC with specific adsorption capabilities. Quenching hot AC with air, oxygen, nitrogen, water, argon, etc. can be utilized to change the surface characteristics of the AC. The pneumatic conveying gas or air blower 18a can be a PD type blower and can be used with inert or reactive gases. The constant volume of a PD blower is helpful in maintaining process consistency and reproducibility.

### Activated Carbon Product Storage 19

The conveyed activated carbon is stored in silo 19. These material silos can be used as final product silos or as intermediate storage. Example silos include mass flow type that refers to a type of silo where the first product entering the silo is the first product out thus ensuring that the inventory is constantly replenished.

### Activated Carbon Product Size Specification Tailoring 20

After storing the AC in the storage silos, the AC can be further refined or treated via treatment unit 20. Such refining or treatment can include sizing, grinding, and chemical treatments. The final product AC can be sold in bulk or packaged as desired.

According to the foregoing, the present disclosure has distinguishing features from other processes. Along with a higher AC yield and the ability to process feedstock into a variety of treated carbons using the same heat-treatment system, process temperature can be controlled using carbon feedstock feed rate and moisture, which allows the conveying gas flows to remain stable without the need to fluctuate other parameters such as combustion air, flue gas recirculation, and primary heat source fuel to adjust and maintain temperature.

Overall, the use of direct contact hot process waste gases provides an upper temperature for calcination that is not exceeded due to the thermal limitation on temperature from the thermal oxidizer. The thermal limitation coupled with the moisture content of the waste gas provides simplified control and advantageous calcination parameters to produce advantageous calcined materials. For example, production of HRM can be achieved in an economically and environmentally practicable manner using processes and apparatus of the present disclosure. Similarly, when HRM of the present disclosure is used for cement applications, the total net CO₂ for producing cement is reduced.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited.

Thus, every point or individual value may serve as its own lower or upper limit combined with any other point or individual value or any other lower or upper limit, to recite a range not explicitly recited.

As is apparent from the foregoing general description and the specific embodiments, while forms of the present disclosure have been illustrated and described, various modifications can be made without departing from the spirit and scope of the present disclosure. Accordingly, the present disclosure is not limited thereby. Likewise whenever a composition, an element or a group of elements is preceded with the transitional phrase “comprising,” it is further contemplated that the same composition or group of elements with transitional phrases “consisting essentially of” “consisting of” “selected from the group of consisting of,” or “is” preceding the recitation of the composition, element, or elements and vice versa may be used.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A process comprising:
heat treating a particulate carbon feedstock in a heating system to form an activated carbon;
removing a waste gas from the heating system; and
introducing the waste gas with a particulate material in a thermal oxidizer coupled with the heating system to form a calcined material.

2. The process of claim 1, wherein the particulate material comprises kaolinite.

3. The process of claim 2, wherein the particulate material comprises greater than 85 wt % kaolinite.

4. The process of claim 1, wherein the particulate material is selected from the group consisting of calcium oxide, calcium carbonate, and combination(s) thereof.

5. The process of claim 1, further comprising removing the calcined material from the thermal oxidizer via a duct disposed at a location that is below ¼ height of the thermal oxidizer.

6. The process of claim 5, wherein the calcined material comprises metakaolin. The process of claim 5, wherein the calcined material comprises gypsum.

8. The process of claim 1, wherein the waste gas has a temperature of about 600° C. to about 1,000° C. at some time while introducing the waste gas with the particulate material.

9. The process of claim 8, wherein the waste gas has a temperature of about 750° C. to about 900° C. at some time while introducing the waste gas with the particulate material.

10. The process of claim 8, wherein the waste gas has a temperature of about 110° C. to about 200° C. at some time while introducing the waste gas with a gypsum particulate material.

11. The process of claim 8, wherein the waste gas comprises about 15 vol % to about 25 vol % water.

12. The process of claim 1, wherein the waste gas comprises fly ash.

13. The process of claim 1, wherein a retention time of the particulate material in the thermal oxidizer is about 0.6 seconds to about 1.5 seconds.

14. The process of claim 1, further comprising:
separating the waste gas from the calcined material using a cyclone collector followed by introducing air to the waste gas or the calcined material.

15. The process of claim 1, further comprising introducing air to a mixture of the waste gas and the calcined material followed by separating the waste gas from the calcined material using a cyclone collector or a dust collector.

16. The process of claim 15, wherein introducing air to the mixture of the waste gas and the calcined material reduces a first temperature of the mixture to a second temperature of about 110° C. to about 200° C.

17. The process of claim 1, wherein the thermal oxidizer is directly coupled with the heating system.

18. A process comprising:
heat treating a particulate carbon feedstock in a heating system to form an activated carbon;
separating a waste gas from the heating system; and
introducing the waste gas with a particulate material in a duct coupled with a thermal oxidizer.

19. The process of claim 18, wherein the duct is disposed in the thermal oxidizer.

20. The process of claim 18, wherein the duct is fluidly coupled with the thermal oxidizer.

21. The process of claim 18, wherein a retention time of the particulate material in the duct of the thermal oxidizer is about 0.6 seconds to about 1.5 seconds.

22. An apparatus comprising:
a heating system coupled with a thermal oxidizer; and
a particulate material source coupled with (1) the thermal oxidizer or (2) a duct coupled with the thermal oxidizer.

23. The apparatus of claim 22, further comprising a dust collector coupled with the thermal oxidizer via a second duct disposed at a location that is below ¼ height of the thermal oxidizer.

24. The apparatus of claim 22, further comprising a cyclone collector coupled with the thermal oxidizer via a second duct disposed at a location that is below ¼ height of the thermal oxidizer.

25. The apparatus of claim 22, wherein the heating system is directly coupled with the thermal oxidizer.

26. The apparatus of claim 22, wherein the particulate material source is directly coupled with the thermal oxidizer at a location that is between ¼ and ¾ height of the thermal oxidizer.

27. The apparatus of claim 22, further comprising:
a cyclone collector coupled with the thermal oxidizer;
a second duct coupled with the cyclone collector at a first end of the second duct and with a second cyclone collector or a dust collector at a second end of the second duct; and
a coolant source coupled with the second duct.

28. The apparatus of claim 22, further comprising:
a second duct coupled with (1) the thermal oxidizer or (2) the duct coupled with the thermal oxidizer;
a coolant source coupled with the second duct; and
a dust collector or cyclone collector coupled with the second duct downstream of the coolant source.

29. A process comprising:
heat treating a particulate carbon feedstock in a heating system to form an activated carbon;
removing a waste gas comprising a fly ash from the heating system; and
(1) separating the waste gas from the fly ash using a cyclone collector followed by introducing a coolant to the waste gas or the fly ash, or
(2) introducing a coolant to a mixture of the waste gas and the fly ash followed by separating the waste gas from the fly ash using a cyclone collector or a dust collector.
